(19) United States
(12) Patent Application Publication
(10) Pub. No.: US 2023/0068720 A1
(43) Pub. Date: Mar. 2, 2023

(54) WORK VEHICLE

(71) Applicant: Kanzaki Kokyukoki Mfg. Co., Ltd., Amagasaki (JP)

(72) Inventors: Akihiro IMA, Amagasaki (JP); Koji KIYOOKA, Amagasaki (JP)

(21) Appl. No.: 17/897,651

(22) Filed: Aug. 29, 2022

(30) Foreign Application Priority Data
Aug. 31, 2021 (JP) 2021-140964

(51) Int. Cl. B60K 17/14; A01D 69/02; B60K 1/02; B60K 17/04; B62D 11/04

(52) U.S. Cl. CPC B60K 17/14; A01D 69/02; B60K 1/02; B60K 17/043; B62D 11/04; A01D 2101/00

(57) ABSTRACT

A work vehicle includes a main body frame and left and right axle drive devices that drive left and right rear wheels. The axle drive devices include left and right electric motors that are housed and fixed in a motor housing that is fixed to the main body frame and left and right gear mechanisms that are housed in gear housings that are fixed to left and right ends of the motor housing and are connected to the respective electric motors to transmit power. A motor shaft of each of the electric motors rotates the corresponding wheel via the corresponding axle-integrated rotating member including the axle. The motor shaft is also arranged to overlap, along the axial direction, with an inner portion of a circumscribing circle of a maximum outer diameter portion of the corresponding axle-integrated rotating member.

### CROSS REFERENCE TO RELATED APPLICATIONS

This application claims priority under 35 U.S.C. § 119 to Japanese Patent Application No. 2021-140964 filed on Aug. 31, 2021, the entire contents of which being incorporated herein by reference.

### BACKGROUND

### Technical Field

The present disclosure relates to a work vehicle including a main body frame and left and right axle drive devices that drive left and right wheels via left and right axles, respectively.

### Related Art

There has been known a conventional work vehicle equipped with a work machine such as a lawn mower. One approach for such a work vehicle is to provide left and right axle drive devices supported by a main body frame, where each axle drive device includes an electric motor to drive a left or right wheel via a left or right axle. The left and right axle drive devices are supported by the main body frame individually and separately.

For example, Japanese Patent No. 6461683 describes an electric lawn mowing vehicle including traveling motors, which are left and right electric motors, each connected to a corresponding wheel, where the rear left and right wheels are driven independently for traveling by the left and right traveling motors. In this vehicle, the left and right traveling motors are housed in a central case, which is a common housing. The case structure, including the central case, is connected to the frame.

In a configuration in which left and right axle drive devices are individually supported by a main body frame, a dedicated connecting bar for connecting the left and right axle drive devices is provided to stably maintain the postures of the two wheels. This connecting bar, which is provided on the opposite side of the electric motors with respect to the axles in the front-rear direction, causes an increased length of the structure including the connecting bar and the axle drive devices in the front-rear direction.

In the configuration described in Japanese Patent No. 6461683, since the two axle drive devices are connected by the central case, a connecting bar for connecting the two axle drive devices is not necessary. However, since the central case is arranged on the front side far apart from the axles of the left and right wheels, when a heavy object such as a battery is arranged on the lower side of the vehicle, it is difficult to arrange the heavy object between the front wheels and the rear wheels in the front-rear direction. It is desirable that a large number of heavy objects mounted on the vehicle are arranged in the central region in the front-rear direction of the vehicle, in terms of improving turning performance and slope traveling performance. For example, if the weight of the vehicle is heavier on the rear side of the rear axle, the ground contact pressure of the front wheels may be low when climbing a slope. As a result, there is room for improvement in terms of optimizing the weight balance.

### SUMMARY

An object of the present disclosure is to provide a work vehicle in which a dedicated connecting bar for connecting two axle drive devices to stably maintain the posture of the two wheels is not required, and a heavy object is arranged on the lower side of the vehicle to facilitate optimization of the weight balance.

A work vehicle according to the present disclosure includes: a main body frame; and left and right axle drive devices that drive left and right rear wheels via left and right axles, respectively, wherein the two axle drive devices include left and right electric motors that are housed and fixed in a motor housing that is fixed to the main body frame, and left and right gear mechanisms that are housed in respective gear housings that are fixed to left and right ends of the motor housing, and are connected to the respective electric motors to transmit power, the left and right axles are connected at output sides of the two gear mechanisms, and each of motor shafts of the electric motors is arranged to rotate the corresponding wheel via an axle-integrated rotating member including the axle, the motor shaft being overlapping, along an axle direction, with an inner portion of a circumscribing circle of a maximum outer diameter portion of the axle-integrated rotating member.

### BRIEF DESCRIPTION OF THE DRAWINGS

FIG. 1 is a perspective view of a work vehicle according to an embodiment of the present disclosure.

FIG. 2 is a simplified configuration diagram of the vehicle of FIG. 1.

FIG. 3 is a rear side view illustrating a front-rear arrangement relationship of a battery with respect to an axle in the vehicle of FIG. 1.

FIG. 4 is a cross-sectional view taken along A-A of FIG. 3.

FIG. 5 is a view in the direction of an arrow B of FIG. 4.

FIG. 6 is a cross-sectional view taken along C-C of FIG. 4.

FIG. 7 is a perspective exploded view of a part of an axle drive device of the vehicle of FIG. 1.

FIG. 8 is an enlarged view of a section D of FIG. 6.

FIG. 9 is a perspective view illustrating a state immediately before a right gear housing is attached to a main body frame.

FIG. 10 is a cross-sectional view taken along E-E of FIG. 9.

FIG. 11 is a view corresponding to FIG. 8 in a work vehicle as a comparative example.

FIG. 12 is a view corresponding to FIG. 10 in another example of the embodiment.

FIG. 13 is a view corresponding to FIG. 8 in still another example of the embodiment.

FIG. 14 is a diagram corresponding to FIG. 3 in yet another example of the embodiment.

FIG. 15 is a cross-sectional view taken along F-F of FIG. 14.

FIG. 16 is a view in the direction of an arrow G of FIG. 15.

FIG. 17 is a cross-sectional view taken along H-H of FIG. 15.

FIG. 18 is an enlarged cross-sectional view taken along I-I of FIG. 16.

FIG. 19 is a view corresponding to FIG. 3 in yet another example of the embodiment.

### DESCRIPTION OF EXEMPLARY EMBODIMENTS

Embodiments of the present disclosure will be described below in detail with reference to the drawings. In the following, a case where a work vehicle is a lawn mowing vehicle will be described. However, the work vehicle is not limited to this, and the work vehicle may be a type of work vehicle including a work machine for doing any one or more of snow removal work, excavation work, civil engineering work, and agricultural work. Also in the following, a case where a left and right-lever type operating means having left and right operating levers is used will be described. However, this is an example, and a steering handle provided on the front side of the seat may be used for a steering device and an accelerator pedal may be used for an accelerator device. The shapes, numbers, materials, and the like described below are examples for explanation and can be changed depending on the specifications of the work vehicle as appropriate. In the following description, similar elements are denoted by the same reference numerals in all the drawings.

### EMBODIMENT

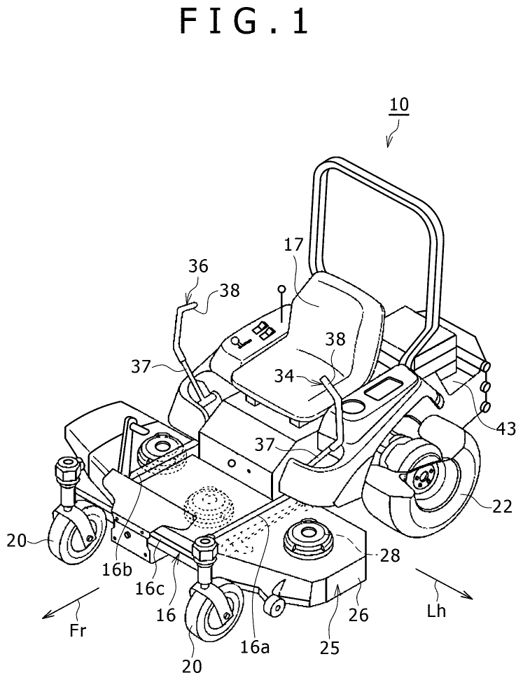

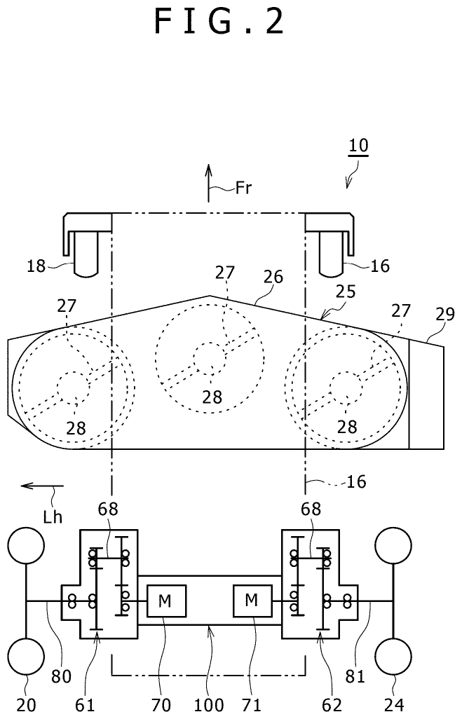

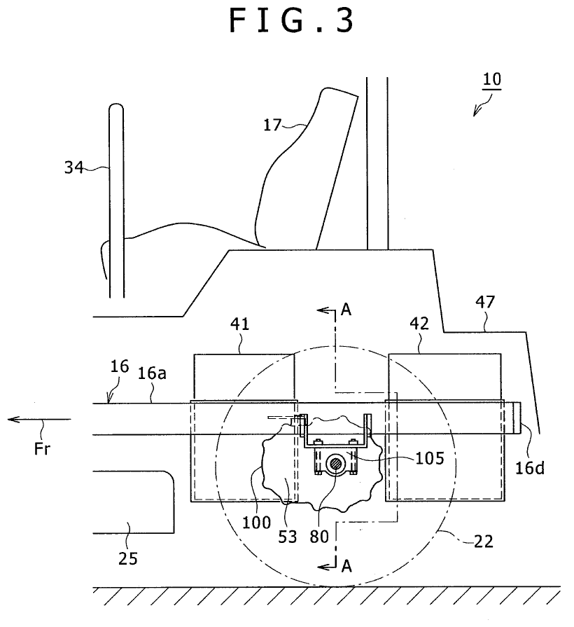

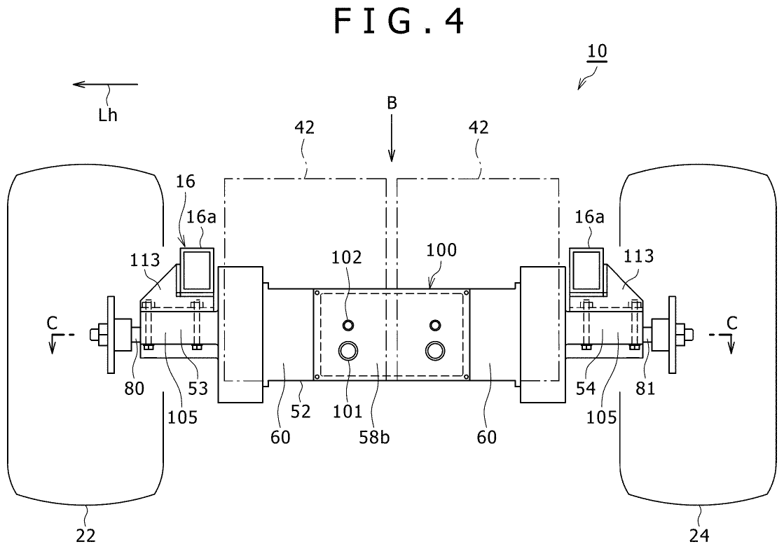

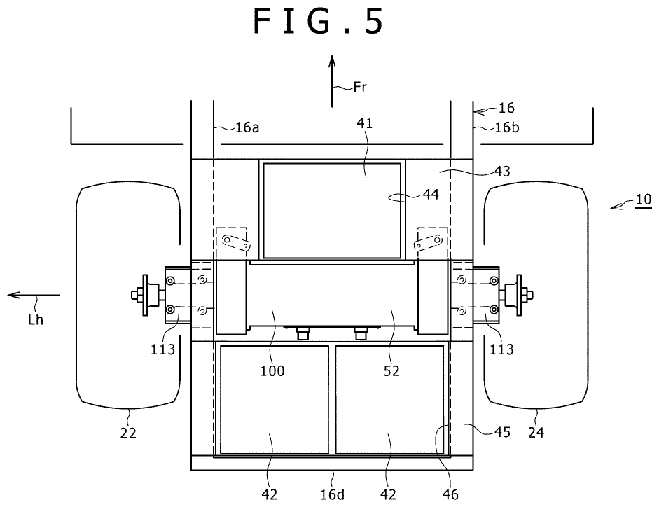

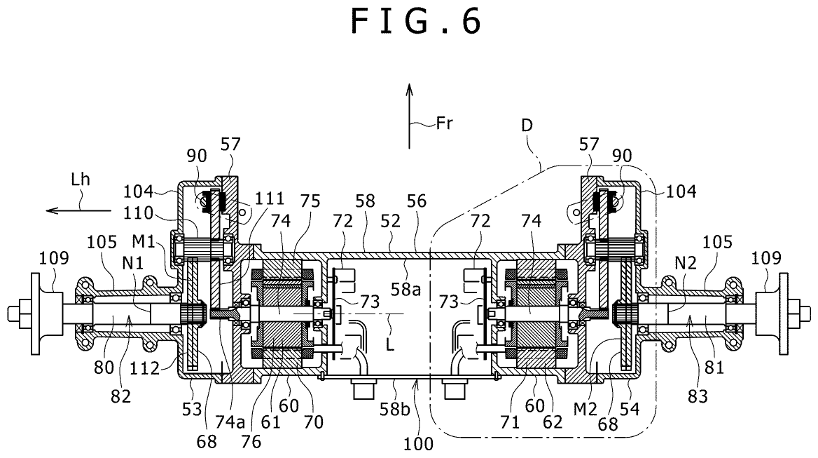

FIG. 1 to FIG. 10 illustrate an embodiment. FIG. 1 is a perspective view of a work vehicle 10 according to the embodiment. FIG. 2 is a simplified configuration diagram of the work vehicle 10. FIG. 3 is a rear side view illustrating a front-rear arrangement relationship of batteries 41 and 42 with respect to an axle 80 in the work vehicle 10. FIG. 4 is a cross-sectional view taken along A-A of FIG. 3. FIG. 5 is a view in the direction of an arrow B of FIG. 4. FIG. 6 is a cross-sectional view taken along C-C of FIG. 4. In the drawings referred to below, the front side is indicated by Fr and the left side is indicated by Lh.

The work vehicle 10 is of a riding type in which a driver sits on a seat 17 and drives and includes a main body frame 16 configuring a vehicle body, caster wheels 18 and 20 which are left and right front wheels, wheels 22 and 24 which are left and right rear wheels (FIG. 3), a lawn mowing device 25 which is a work machine, and left and right operating levers 34 and 36.

As illustrated in FIG. 1 and FIG. 3 to FIG. 5, the main body frame 16 is formed of two main frames 16a and 16b and a plurality of transverse frames 16c and 16d, which are connected to each other. The main frames 16a and 16b extend substantially in the front-rear direction on both left and right sides. The transverse frames 16c and 16d extend substantially in the transverse direction. FIG. 1 and FIGS. 3 to FIG. 5 illustrate only two transverse frames 16c and 16d at the front end and the rear end, respectively, among the plurality of transverse frames 16c and 16d. The seat 17 is arranged and fixed on the upper side of a middle portion of the main body frame 16 in the front-rear direction. The left and right caster wheels 18 and 20 are supported by the main body frame 16 on the front side. Each of the caster wheels 18 and 20 enables free steering of 360 degrees or more centered on the vertical axis. The left and right wheels 22 and 24 are rotatably attached to the main body frame 16 on the rear side. The left and right wheels 22 and 24 are main drive wheels and are driven by two left and right electric motors 70 and 71 for traveling (FIG. 2) configuring left and right axle drive devices 61 and 62 (FIG. 2) described later. The electric motors 70 and 71 are supplied with electric power from the plurality of batteries 41 and 42 (FIG. 3) via their respective inverter devices 72 (FIG. 6). Each inverter device 72 includes electrical components such as an inverter circuit and a capacitor, which are fixed to a substrate 73. The inverter device 72 may include a contactor, a bus bar, and a fuse. Each inverter device 72 is fixed in the inside of a motor housing 52 described later.

As illustrated in FIG. 3 to FIG. 5, the plurality of batteries 41 and 42 include one battery 41 arranged on the front side of the motor housing 52 and two batteries 42 arranged side by side on the rear side of the motor housing 52. The battery 41 on the front side is inserted and fixed in a bottomed recess 44, having a rectangular cross section, which is formed in the middle, in the vehicle width direction which is the left-right direction, of a front plate 43 that extends between and is fixed to upper surfaces of the main frames 16a and 16b which are on the front side from portions where the motor housing 52 is fixed. The two batteries 42 on the rear side are inserted and fixed in a bottomed recess 46 having a rectangular cross section and being long in the transverse direction, in a rear plate 45 that extends between and is fixed to upper surfaces of the main frames 16a and 16b which are on the rear side from portions where the motor housing 52 is fixed. In this state, the plurality of batteries 41 and 42 are arranged below the seat 17. The plurality of batteries 41 and 42 are electrically connected in parallel or in series with each other. For example, the electrodes of the plurality of batteries 41 and 42 are connected to the two electric motors 70 and 71 via the respective inverter devices 72. The upper side of the plurality of batteries 41 and 42 is covered with a battery cover 47.

The inverter devices 72 convert DC power supplied from the batteries 41 and 42 into AC power and output the AC power to the electric motors 70 and 71, respectively. The electric motors 70 and 71 may be supplied with electric power from only one of the plurality of batteries 41 and 42 via the corresponding inverter device 72.

Instead of the two caster wheels 18 and 20, for example, only one of them may be provided in the work vehicle 10, or three or more caster wheels may be provided.

The lawn mowing device 25 is supported by the middle portion of the main body frame 16 in the front-rear direction on the lower side. The lawn mowing device 25 includes a mower deck 26 and three lawn mowing blades 27 (FIG. 2), which are rotary tools for mowing that can rotate around vertical axes, respectively, inside the mower deck 26. Each lawn mowing blade 27 is rotated to shear grass or the like, enabling mowing. Each lawn mowing blade 27 is driven by an electric motor 28 for a mower.

The lawn can be mowed by the rotation of the lawn mowing blade 27, and the mowed grass is discharged from the inside of the mower deck 26 to one side in the vehicle width direction through a duct 29 (FIG. 2).

The lawn mower may be provided with, for example, a spiral blade on a rotating shaft parallel to the ground surface as the rotary tool for mowing, and may include a lawn mowing reel, having a function of mowing grass and the like, which is driven by a deck motor.

The two left and right operating levers 34 and 36 are provided on the left and right sides of the seat 17, respectively, to be swingable in the front-rear direction about the horizontal axis in the vehicle width direction. Each of the operating levers 34 and 36 is provided with a straight portion 37 on the lower side and provided with a grip portion 38 bent inward in the vehicle width direction on the upper side. When the straight portion 37 of each of the operating levers 34 and 36 is in an upright state, which is a neutral state, the corresponding one of the electric motors 70 and 71 for traveling stops rotating; when the straight portion 37 is operated to swing, an instruction is issued to change the rotation direction and rotation speed of the corresponding one of the electric motors 70 and 71 depending on the swing direction and swing amount.

The swing position of each of the operating levers 34 and 36 in the front-rear direction is detected by a lever sensor (not illustrated). A detection signal from the lever sensor is input to a control device (not illustrated) mounted on the vehicle as a signal indicating a rotation instruction for the corresponding one of the electric motors 70 and 71, and then, the control device causes the corresponding one of the electric motors 70 and 71 to rotate in the rotation direction indicated by the instruction. The power of the electric motors 70 and 71 is transmitted to the left and right wheels 22 and 24 via gear mechanisms 68 configuring the axle drive devices 61 and 62 together with the electric motors 70 and 71, respectively. As a result, the vehicle travels forward or backward according to the operations of the operating levers 34 and 36, and the vehicle turns according to a difference in rotation speed between the left and right wheels 22 and 24, which is generated according to changes in the operation amounts of the left and right operating levers 34 and 36. When one of the two operating levers 34 and 36 is tilted forward and the other operating lever is tilted backward, the left and right wheels 22 and 24 rotate in opposite directions, so that the vehicle turns sharply with a small turning radius.

The two operating levers 34 and 36 have a parking brake position which is a tilted position to which their straight portions 37 are moved (opened) outward in the vehicle width direction from the upright state, which is the neutral state. The two operating levers 34 and 36 have a function of instructing the activation of the parking brake when they are moved to the parking brake position. The lower ends of the operating levers 34 and 36 and brake devices 90 (FIG. 6) described later provided in the axle drive devices 61 and 62, respectively, are connected by link mechanisms, and when the operating levers 34 and 36 are opened outward, the brake devices 90 are activated to brake the respective wheels 22 and 24.

As described above, the work vehicle 10 is provided with the left and right axle drive devices 61 and 62 including the electric motors 70 and 71 to drive the left and right wheels 22 and 24. If the axle drive devices 61 and 62 are supported separately and individually by the main body frame 16, a dedicated connecting bar for connecting the left and right axle drive devices is required to stably maintain the postures of the two wheels 22 and 24.

As in the configuration described in Japanese Patent No. 6461683, when two axle drive devices are connected by the central case and the central case is arranged on the front side apart from the axles of the left and right wheels, the central case obstructs arrangement of a heavy object such as a battery on the lower side of the vehicle to lower the center of gravity. Accordingly, there is room for improvement in terms of optimizing the weight balance.

In the work vehicle 10 of the present example, to optimize such weight balance, in the left and right axle drive devices 61 and 62, the left and right electric motors 70 and 71 (FIG. 6) are housed and fixed in the common motor housing 52 fixed to the main body frame 16. As illustrated in FIG. 6, in each of left and right gear housings 53 and 54 that are fixed to the left and right ends of the motor housing 52, the corresponding gear mechanism 68 of the left and right gear mechanisms 68 is housed. Each gear mechanism 68 is connected to the corresponding one of the electric motors 70 and 71 to transmit power. The left and right axles 80 and 81 are connected to the two gear mechanisms 68 on the output side, respectively. A motor shaft 74 of each of the left and right electric motors 70 and 71 rotates the corresponding one of the wheels 22 and 24 via the respective one of axle-integrated rotating members 82 and 83 including the axles 80 and 81. The motor shaft 74 is also arranged to overlap, along the axle direction, with an inner portion of a circumscribing circle of a maximum outer diameter portion of the corresponding one of the axle-integrated rotating members 82 and 83.

Specifically, a housing unit 100 is fixed to the outside, in the vehicle width direction, of the left and right main frames 16a and 16b extending in the front-rear direction, of the main body frame 16. The housing unit 100 includes the motor housing 52 and the gear housings 53 and 54 that are fixed to respective ends of the motor housing 52 in the vehicle width direction.

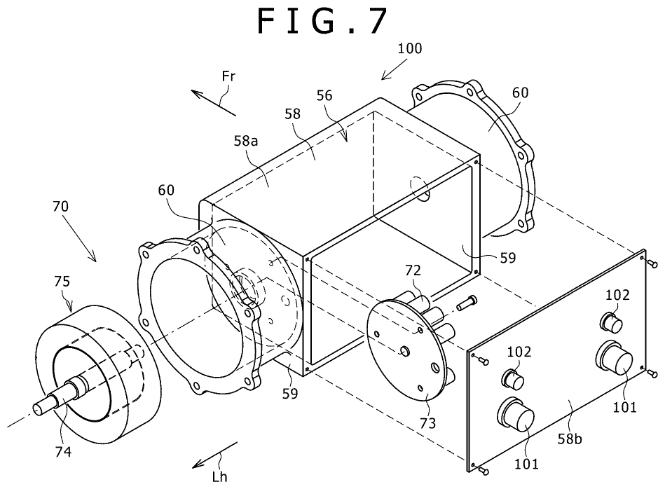

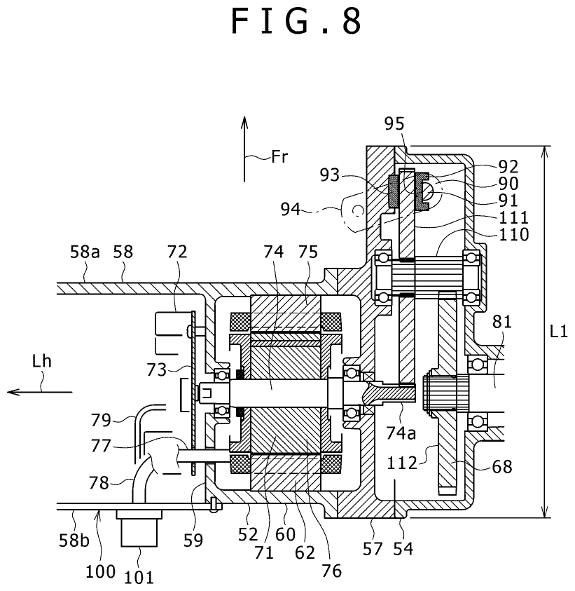

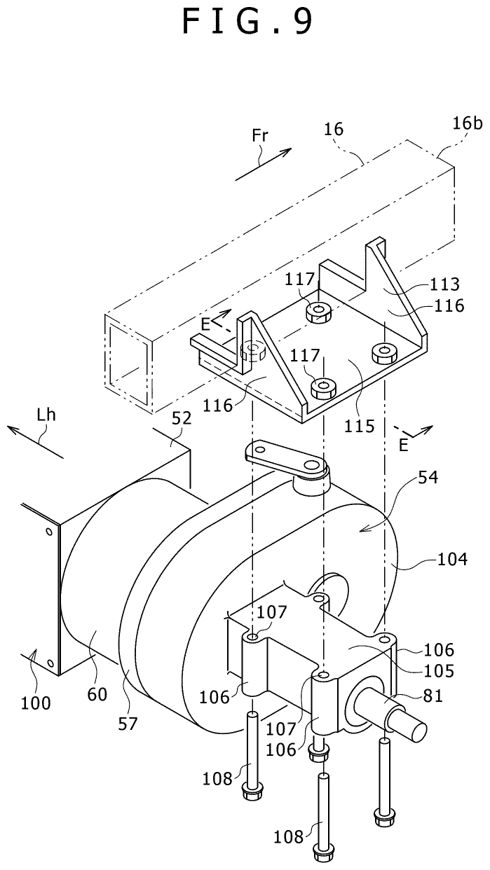

FIG. 7 is a perspective exploded view of a part of the axle drive device 61. FIG. 8 is an enlarged view of a section D of FIG. 6. FIG. 9 is a perspective view illustrating a state immediately before the right gear housing 54 is attached to the main body frame 16.

As illustrated in FIG. 6, the left and right electric motors 70 and 71 are housed and fixed in the motor housing 52 configuring the housing unit 100. The motor housing 52 has a housing body 56, and wall members 57 coupled to the left and right ends of the housing body 56, respectively. As illustrated in FIG. 7, the housing body 56 includes a central case 58 that is provided in the middle in the vehicle width direction and has a substantially rectangular parallelepiped box shape which is long in the vehicle width direction, and substantially cylindrical end cases 60 that are integrated with outer sides of side walls 59 at both left and right ends of the central case 58. In the central case 58, a flat plate-shaped cover 58b is screwed and fixed to a substantially rectangular parallelepiped box portion 58a having a rear end opening, to close the opening.

The electric motors 70 and 71 are housed inside the respective end cases 60. Each of the electric motors 70 and 71 includes a stator 75 that is fixed to the inner surface of the end case 60, and a rotatable rotor 76 that is arranged radially inside the stator 75 and fixed to the motor shaft 74. The motor shaft 74 is rotatably supported by circular holes that are formed in the side wall 59 and the wall member 57 of the central case 58, via a bearing. The motor shafts 74 of the left and right electric motors 70 and 71 are arranged to overlap with each other along an axial direction L (FIG. 6).

As illustrated in FIG. 8, the substrate 73 of each inverter device 72 is screwed and fixed to the inner surface of the corresponding side wall 59, at both left and right ends inside the central case 58. Each of the electric motors 70 and 71 is connected to the corresponding inverter device 72 by a first cable 77 penetrating the side wall 59.

The inverter device 72 is connected to the corresponding one of the batteries 41 and 42 (FIG. 3) via a second inner cable 78 inside the central case 58 and a second outer cable (not illustrated) outside the central case 58. The inverter device 72 and the control device are connected via a third inner cable 79 inside the central case 58 and a third outer cable (not illustrated) outside the central case 58. Accordingly, as illustrated in FIGS. 7 and 8, second connectors 101 for power system to which ends of the two second inner cables 78 are connected and third connectors 102 for signal system to which the two third inner cables 79 are connected are attached to the cover 58b. On the outside of the cover 58b, the second outer cables connected to the batteries 41, 42 are connected to the second connectors 101, respectively. The third outer cables connected to the control device are connected to the respective third connectors 102. As a result, it is not necessary to lead out the cables from the cover 58b before assembling the housing unit 100 to the vehicle, so that the transportation work of the housing unit 100 becomes easy.

The cover 58b may be provided with no connector, and instead, the cover 58b may have one or more holes through which pass second cables for connecting the inverter devices 72 and the batteries 41 and 42 and third cables for connecting the inverter devices 72 and the control device. In this case, the holes of the cover 58b may be filled with a sealing material to prevent moisture from entering the holes of the cover 58b through gaps between the holes and the cables.

In a surplus space between the left and right inverter devices 72 inside the central case 58, inverter devices (not illustrated) for driving the electric motors 28 for mower arranged in the vicinity of the axle drive devices 61 may be provided. With such a configuration, the space inside the motor housing 52 can be further effectively used. The integration of the inverter devices enables efficient cooling of each inverter device by means of, for example, air cooling or liquid cooling.

On the other hand, the wall member 57 is fixed to the outer end portion of the end case 60 in the vehicle width direction by screw connection. The wall member 57 has a substantially elliptical plate shape that is long in the front-rear direction. The inner end portions of the gear housings 53 and 54 in the vehicle width direction are abutted against the outer surfaces of the wall members 57 in the vehicle width direction, respectively, and are fixed by screw connection. In FIG. 9, the gear housing 54 and the wall member 57 are illustrated in a simplified manner, such as omitting the screw joints between the gear housing 54 and the wall member 57.

The gear housing 54 has a gear case portion 104 that is provided at an inner end in the vehicle width direction, and a tubular portion 105 that extends in the vehicle width direction from a wall portion at an outer end of the gear case portion 104 in the vehicle width direction. As illustrated in FIG. 9, the outer shape of the tubular portion 105 is a substantially rectangular parallelepiped, and through holes 107 having a circular cross section extending in the vertical direction are formed in a plurality of protrusions 106 that protrude from the side surfaces of both front and rear ends. As will be described later, bolts 108 for connection to the main body frame 16 penetrate through the respective through holes 107 in the vertical direction. The gear mechanism 68 is housed inside the gear case portion 104. The axle 81 penetrates the tubular portion 105, and the axle 81 is rotatably supported with respect to the tubular portion 105 by a bearing provided in the tubular portion 105. A hub 109 is fixed to an outer end portion of the axle 81 protruding from the tubular portion 105. The wheels 22 and 24 are fixed to the respective hubs 109.

As illustrated in FIG. 6, with the left and right gear housings 53 and 54 being fixed to the motor housing 52, the gear case portions 104 of the gear housings 53 and 54 protrude forward with respect to the motor housing 52.

The gear mechanism 68 includes a gear shaft 110 that is rotatably supported by the gear case portion 104 via a bearing on the front side with respect to the motor shaft 74, a first gear 111 that is fixed to the gear shaft 110 and meshes with a gear portion 74a formed at an outer end of the motor shaft 74, and a second gear 112 that is fixed to an inner end portion of the corresponding one of the axles 80 and 81 in the vehicle width direction and meshes with a gear portion formed on the gear shaft 110. The second gears 112 are fixed to the inner end portions of the axles 80 and 81. The axles 80 and 81 are arranged on the rear side with respect to the gear shaft 110.

Each of the motor shafts 74 of the left and right electric motors 70 and 71 is arranged substantially coaxially with the corresponding one of the axles 80 and 81. As a result, the left and right axles 80 and 81 and the motor shafts 74 of the left and right electric motors 70 and 71 are all arranged on substantially the same straight line.

Accordingly, each gear mechanism 68 is connected to the corresponding one of the electric motors 70 and 71 to transmit power. The left and right axles 80 and 81 are connected to the two gear mechanisms 68 on the output side, respectively.

Each of the left and right axles 80 and 81 is integrally fixed with the corresponding second gear 112 and hub 109 to form the corresponding one of the axle-integrated rotating members 82 and 83. The motor shafts 74 of the electric motors 70 and 71 rotate the wheels 22 and 24 via the axle-integrated rotating members 82 and 83 including the axles 80 and 81, respectively. Each motor shaft 74 is also arranged to overlap, along the axle direction, with the corresponding one of virtual disk portions M1 and M2 (FIG. 6) that are inner portions of circumscribing circles of the maximum outer diameter portions of the second gears 112, which are the maximum outer diameter portions of the axle-integrated rotating members 82 and 83. The motor shafts 74 are arranged to overlap, along the axle direction, with inner portions N1 and N2 (FIG. 6) of the circumscribing circles of the maximum outer diameter portions of the axles 80 and 81, respectively.

The axle drive devices 61 and 62 are configured to include the left and right electric motors 70 and 71 and the gear mechanisms 68, respectively. The left and right axle drive devices 61 and 62 and the left and right axles 80 and 81 are assembled to the housing unit 100 including the motor housing 52, and the housing unit 100 is fixed to the main body frame 16.

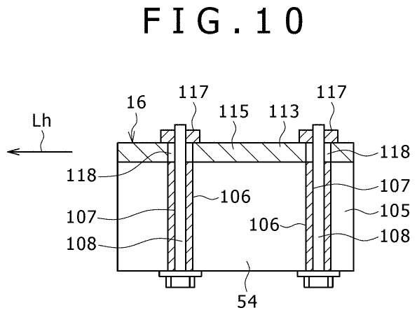

Specifically, support plate portions 113 are fixed to the main frames 16a and 16b at the outside in the vehicle width direction by welding or the like. Each support plate portion 113 has a plate portion 115 extending in the horizontal direction. and wall portions 116 standing at both ends in the front-rear direction. Elongated holes 118 (FIG. 10) are formed in the plate portion 115 at positions corresponding to a plurality of nuts 117 in FIG. 9.

FIG. 10 is a cross-sectional view taken along E-E in FIG. 9. As illustrated in FIG. 10, the bolts 108 for fixing the housing unit 100 are inserted into the elongated holes 118 formed in the plate portion 115. Each elongated hole 118 has an oval cross section that is elongated in the left-right direction, in which the length in the left-right direction is longer than the length in the front-rear direction. With the threaded portion of the bolt 108 being inserted into the elongated hole 118, a gap is formed in the left-right direction between the elongated hole 118 and the threaded portion. The bolt 108 corresponds to a fastening member.

The upper end portions of the bolts 108 inserted vertically from below into the through holes 107 of each tubular portion 105 of the two gear housings 54 are further inserted into the elongated holes 118 of the corresponding plate portion 115 to be coupled with the nuts 117 laid above. Accordingly, the two gear housings 54 are fixed to the main body frame 16 by the bolts 108 inserted vertically with respect to the main body frame 16.

As illustrated in FIG. 8, each of the axle drive devices 61 and 62 is provided with the brake device 90. The brake device 90 includes the first gear 111, a cam shaft 91 rotatably supported along the vertical direction with respect to the gear housing 54, a brake shoe 92 and a brake pad 93 which are arranged in the gear housing 54, and a brake arm 94 fixed to the upper end of the cam shaft 91. A semicircular cross-sectional portion having a cam surface 95 is formed where the cam shaft 91 is arranged in the gear housing 54. The cam surface 95 faces the brake shoe 92, which can move in the vehicle width direction. The brake shoe 92 is arranged between the cam shaft 91 and the first gear 111. The brake pad 93 is attached to a portion of the wall member 57 facing the first gear 111.

When the cam surface 95 is located in parallel with the brake shoe 92, the brake shoe 92 is separated from the first gear 111, which is in a non-braking state. On the other hand, when the cam surface 95 is tilted with respect to the brake shoe 92 by rotation of the cam shaft 91, the cam surface 95 is pressed against the brake shoe 92. As a result, the first gear 111 is sandwiched between the brake pad 93 and the brake shoe 92 from both sides, so that the corresponding one of the wheels 22 and 24 to which power is transmitted from the first gear 111 is braked.

To the distal end portion of the brake arm 94, the lower end of the corresponding one of the operating levers 34 and 36 (FIG. 1) is connected via a link mechanism (not illustrated). A spring (not illustrated) is arranged between the circumference of the cam shaft 91 on the outer surface of the gear housing 54 and the brake arm 94, and the spring biases the cam shaft 91 in a first rotation direction via the brake arm 94 so that the cam surface 95 and the brake shoe 92 are parallel with each other to be in the non-braking state. On the other hand, when the operating levers 34 and 36 are operated to be in the parking brake position, the distal end portions of the brake arms 94 move against the biasing force of the respective springs, and each cam shaft 91 rotates in a second rotation direction in which the cam surface 95 is tilted with respect to the brake shoe 92 to press the brake shoe 92 against the first gear 111. The second rotation direction is opposite to the first rotation direction. As a result, the brake device 90 enters a braking state, the rotation of the wheels 22 and 24 is stopped, and the state is maintained.

According to the work vehicle 10 described above, the motor housing 52 in which the two left and right electric motors 70 and 71 are housed is fixed to the main body frame 16, and the motor shafts 74 of the electric motors 70 and 71 rotate the wheels 22 and 24 via the respective axle-integrated rotating members 82 and 83. This eliminates the need to provide a dedicated connecting bar for connecting the two axle drive devices 61 and 62 for stably maintaining the postures of the two wheels 22 and 24. The motor shaft 74 of each of the electric motors 70 and 71 is arranged to overlap, along the axle direction, with the corresponding one of the inner portions M1 and M2 (FIG. 6) of circumscribing circles of the maximum outer diameter portions of the axle-integrated rotating members 82 and 83. As a result, it is possible to obviate arrangement of the motor housing 52, which houses the electric motors 70 and 71, on the front side far apart from the axles 80 and 81. If the motor housing 52 is on the front side far apart from the axles 80 and 81, a space between the lawn mowing device 25 and the motor housing 52 becomes narrow, which makes it difficult to arrange a heavy object there. For example, if the heavy object is the battery 41, it is required to be placed above the motor housing 52, so that the vehicle cannot be designed to have a low center of gravity. Alternatively, if the battery 41 cannot be arranged in such a place due to the layout of vehicle parts, the batteries 41 and 42 will be concentrated behind the motor housing 52. In the present embodiment, it is possible to secure a battery placement space in front of the lawn mowing device 25 and the motor housing 52, which makes it easy to arrange the heavy battery 41 on the lower side of the vehicle and in front of the axles 80 and 81. Therefore, it becomes easy to optimize the weight balance of the work vehicle 10 in the vertical direction and the front-rear direction.

The motor shafts 74 of the two electric motors 70 and 71 are arranged to overlap with each other along the axial direction, so that it is possible to further obviate arrangement of the motor housing 52, which houses the two electric motors 70 and 71, on the front side far apart from the axles 80 and 81. This makes it easier to optimize the weight balance.

The motor shafts 74 of the electric motors 70 and 71 are arranged to overlap, along the axle direction, with the inner portions N1 and N2 (FIG. 6) of the circumscribing circles of the maximum outer diameter portions of the axles 80 and 81, respectively. This also makes it possible to further obviate arrangement of the motor housing 52 on the front side far apart from the axles 80 and 81, so that it becomes easier to optimize the weight balance.

The motor shaft 74 of each of the electric motors 70 and 71 is arranged substantially coaxially with the corresponding one of the axles 80 and 81. This also makes it possible to further obviate arrangement of the motor housing 52 on the front side far apart from the axles 80 and 81, so that it becomes easier to optimize the weight balance.

The two gear housings 53 and 54 are fixed to the main body frame 16 by the bolts 108 inserted in the vertical direction with respect to the main body frame 16. The main body frame 16 is formed with the elongated holes 118 which are long in the left-right direction and into which the bolts 108 are inserted. As a result, unlike the case where the two gear housings are fixed to the main body frame 16 by bolts inserted in the left-right direction, even if there is an error in the distance between the two gear housings 53 and 54 in the left-right direction or the attachment position to the main body frame 16 in the left-right direction, the gear housings 53 and 54 can be easily attached to the main body frame 16 without using troublesome means such as adding a spacer or using a low-rigidity material for the main body frame. In the configuration of the present example, the case where the bolts are inserted into the gear housings 53 and 54 and the main body frame 16 from below has been described. However, the bolts may be inserted into the gear housings 53 and 54 and the main body frame 16 from above to be coupled with the lower ends of the bolts.

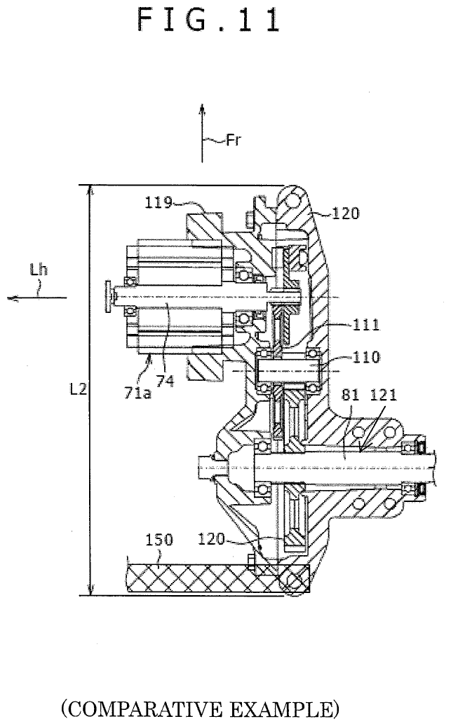

FIG. 11 is a view corresponding to FIG. 8 in a work vehicle serving as a comparative example. In the work vehicle serving as the comparative example, unlike the embodiments of FIG. 1 to FIG. 10, two left and right electric motors 71a are not housed in a common motor housing. In the work vehicle serving as the comparative example, in a state where the motors are housed in different motor housings 119, the respective motor housings 119 are separated and fixed to a main body frame (not illustrated). FIG. 11 illustrates only part of the motor housings 119. Inside a gear housing 120 fixed to the motor housing 119 outside in the vehicle width direction, there are provided a first gear 111 fixed to the end of the motor shaft 74, a gear shaft 110 that is arranged behind the motor shaft 74 and has a gear portion that meshes with the first gear 111, and a second gear 112 that is fixed to an axle 81 arranged behind the gear shaft 110 and meshes with the gear portion of the gear shaft 110. The second gear 112 is fixed to the inner end of the axle 81. As a result, the electric motor 71a is arranged on the front side far apart from the axle 81. The motor shaft 74 of each of the electric motors 71a does not overlap, along the axle direction, with the inner portion of the circumscribing circle of the second gear 112, which is the maximum outer diameter portion of the axle-integrated rotating member 121 including the corresponding axle 81. In such a comparative example, a length L2 of the portion including the gear housing 120 and the motor housing 119 in the front-rear direction tends to be large. In the comparative example of FIG. 11, to stably maintain the postures of the two wheels, for the two left and right axle drive devices, a dedicated connecting bar 150 for connecting the drive devices is provided in a position opposite to the electric motors 71a with respect to the axles 81 in the front-rear direction (a position indicated by a diagonal grid of FIG. 11). Even with this, in the comparative example, the length L2 in the front-rear direction tends to be large.

In contrast, according to the embodiment illustrated in FIG. 6 and others, the motor shaft 74 of each of the electric motors 70 and 71 is arranged to overlap, along the axle direction, with the corresponding one of the inner portions M1 and M2 (FIG. 6) of circumscribing circles of the maximum outer diameter portions of the axle-integrated rotating members 82 and 83. As a result, a length L1 of the housing unit 100 including the motor housing 52 and the gear housings 53 and 54 in the front-rear direction can be made smaller than the length L2 of the portion including the gear housing 120 and the motor housing 119 in the front-rear direction in the comparative example of FIG. 11.

### First Example as Another Example of Embodiment

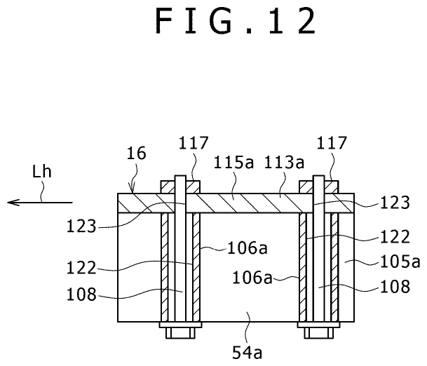

FIG. 12 is a view corresponding to FIG. 10 in another example of the embodiment. In the configuration of the present example, unlike the configurations of FIGS. 9 and 10, in each of protrusions 106a formed in a tubular portion 105a of a gear housing 54a, an elongated hole 122 having an oval cross section that is long in the left-right direction is formed to penetrate in the vertical direction, instead of the through hole having a circular cross section. In a support plate portion 113a fixed to the main frame 16b (FIG. 9), a plurality of circular holes 123 having a circular cross section for bolt insertion are formed, instead of the plurality of elongated holes.

Bolts 108 are inserted vertically from below into the respective elongated holes 122 of each of the two gear housings 54a. The upper end portions of the bolts 108 are inserted into the circular holes 123 of the corresponding plate portion 115a to be coupled with the nut 117 laid above. Accordingly, the two gear housings 54a are fixed to the main body frame 16 by the bolts 108 inserted vertically with respect to the main body frame 16.

With such a configuration as well, similar to the configurations of FIG. 1 to FIG. 10, even if there is an error in the distance between the two gear housings 54a in the left-right direction or the attachment position to the main body frame 16 in the left-right direction, the gear housings 54a can be easily attached to the main body frame 16 without using troublesome means such as adding a spacer or using a low-rigidity material for the main body frame. In the present example, the other configurations and operations are similar to those illustrated in FIG. 1 to FIG. 10.

### Second Example as Still Another Example of Embodiment

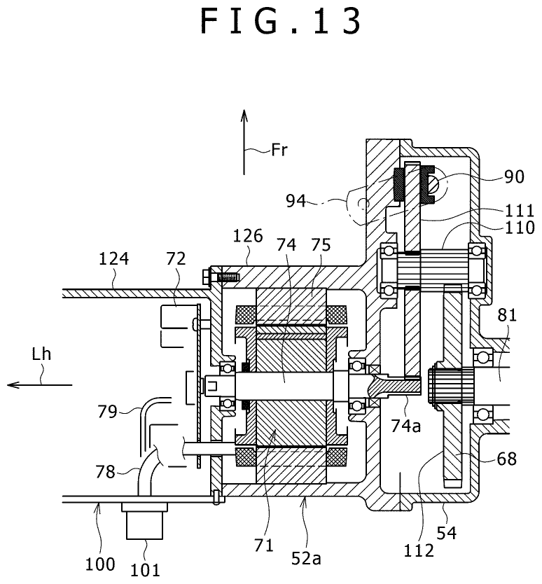

FIG. 13 is a view corresponding to FIG. 8 in still another example of the embodiment. In the configuration of the present example, unlike the configuration of FIG. 8, a motor housing 52a includes a box-shaped intermediate housing 124 in which at least two left and right inverter devices 72 are housed, and an outer housing 126 that is screwed and fixed to both left and right ends of the intermediate housing 124. Each inverter device 72 is fixed to both left and right ends of the inner surface of the intermediate housing 124. The outer housings 126 house the left and right electric motors 71, respectively. The outer housing 126 has a shape such that the end case 60 of the motor housing 52 is integrally formed with the wall member 57 in the housing unit 100 illustrated in FIG. 8. The two gear housings 54 are fixed to the outer ends of the outer housings 126 in the vehicle width direction, respectively. In the present example, the other configurations and operations are similar to those illustrated in FIG. 1 to FIG. 10.

### Third Example as Yet Another Example of Embodiment

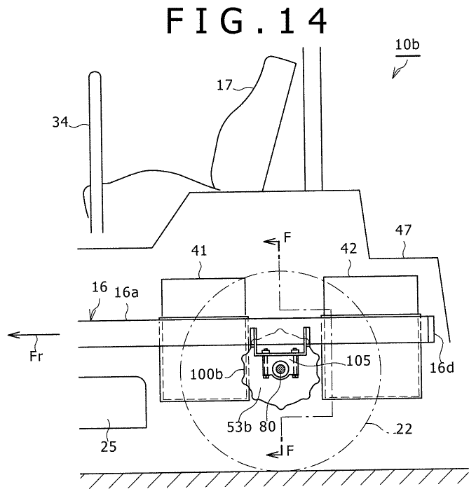

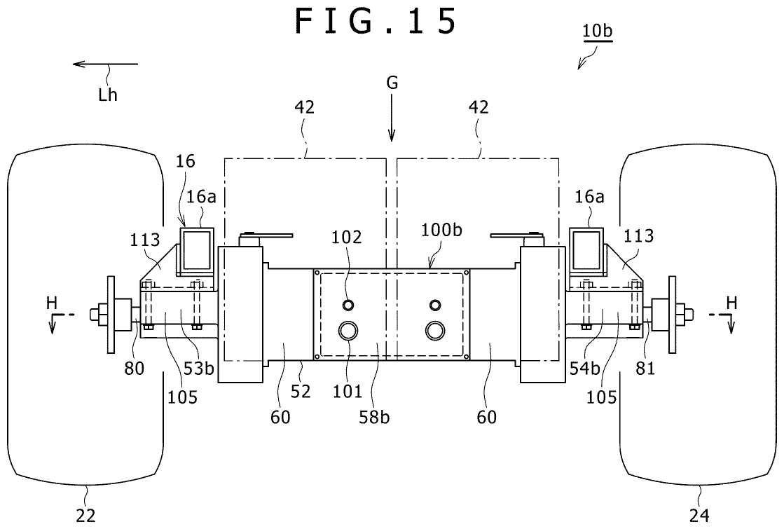

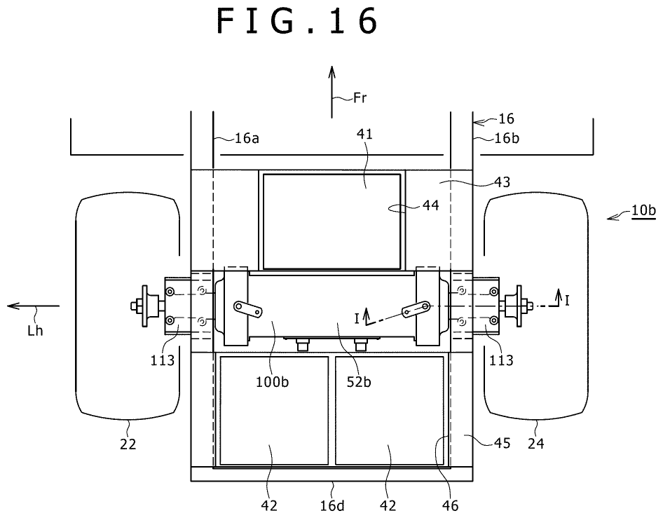

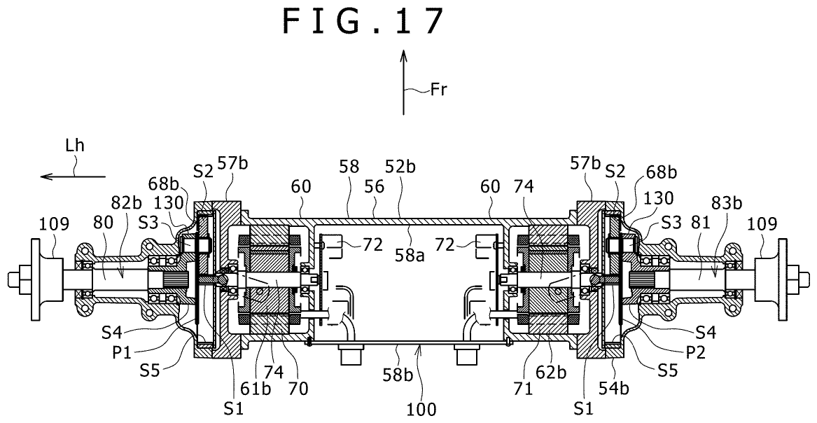

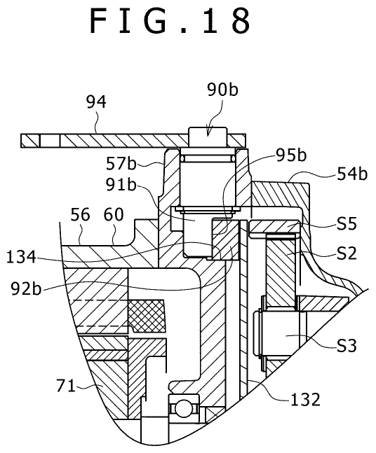

FIG. 14 is a diagram corresponding to FIG. 3 in yet another example of the embodiment. FIG. 15 is a cross-sectional view taken along F-F of FIG. 14. FIG. 16 is a view in the direction of an arrow G of FIG. 15. FIG. 17 is a cross-sectional view taken along H-H of FIG. 15. FIG. 18 is an enlarged cross-sectional view taken along I-I of FIG. 16.

In a work vehicle 10b of the present example, in a housing unit 100b, wall members 57b (FIG. 17) are fixed to both ends of the motor housing 52b (FIG. 15 to FIG. 17) in the vehicle width direction, and gear housings 53b and 54b (FIG. 17) are fixed to the respective wall member 57b outside in the vehicle width direction. In the configuration of the present example, gear mechanisms 68b are each configured by a planetary gear mechanism. Specifically, as illustrated in FIG. 17, the gear mechanism 68b includes a sun gear S1 that is formed in a portion of the corresponding one of the motor shafts 74 of the electric motors 70 and 71 arranged in the respective gear housings 53b and 54b, a plurality of planetary gears S2 that are arranged in the corresponding one of the gear housings 53b and 54b and mesh with the sun gear S1, a plurality of planetary shafts S3 that rotatably support the respective planetary gears S2, and carriers S4 that support the respective planetary shafts S3. In FIG. 17, only one planetary gear S2 and one planetary shaft S3 are illustrated. The carrier S4 is fixed to the inner end of the corresponding one of the axles 80 and 81 to rotate together.

The gear mechanism 68b includes a ring gear S5 fitted and fixed to the inner peripheral surface of the inner end portion of the corresponding one of the gear housings 53b and 54b. The gear portion of the ring gear S5 meshes with the corresponding planetary gear S2. As a result, the planetary gear S2 rotates and revolves around the sun gear S1 with the rotation of the motor shaft 74, and the rotation of the motor shaft 74 is transmitted to the corresponding one of the axles 80 and 81 via the gear mechanism 68b. Axle drive devices 61b and 62b are configured to include the electric motors 70 and 71 and the gear mechanisms 68b, respectively. Axle-integrated rotating members 82b and 83b include the axles 80 and 81, the hubs 109, and the carriers S4, respectively.

The motor shaft 74 of each of the electric motors 70 and 71 is arranged to overlap, along the axle direction, with the corresponding one of the inner portions P1 and P2 of circumscribing circles of the maximum outer diameter portions of the axle-integrated rotating members 82b and 83b. In the case of the present example, the circumscribing circle of the maximum outer diameter portion is a circumscribing circle in contact with outer peripheral surfaces 130 of the support portions of the plurality of planetary shafts S3 of the carriers S4. The motor shaft 74 of each of the electric motors 70 and 71 is arranged substantially coaxially with the corresponding one of the axles 80 and 81.

As illustrated in FIG. 18, a brake device 90b is configured by sandwiching a brake shoe 92b and a brake rotor 132 between a cam surface 95b of a cam shaft 91b to which the brake arm 94 is fixed and the ring gear S5. The brake shoe 92b is arranged on a step portion 134 formed on the outer peripheral portion of the wall member 57b. The inner peripheral portion of the brake rotor 132 is fitted and fixed to the motor shaft 74 (FIG. 17). When the operating levers 34 and 36 (FIG. 1) are operated to be in the parking brake position, the movement of the distal end portions of the brake arms 94 rotates the cam shafts 91b in a second rotation direction in which the cam surface 95b is tilted with respect to the brake shoe 92b to press the brake shoe 92b against the brake rotor 132. As a result, the brake device 90b enters the braking state, and the rotation of the wheels 22 and 24 (FIG. 2) is stopped.

In the configuration of the present example, the outer diameter of each planetary gear S2 can be reduced, so that it is easy to prevent the gear housings 53b and 54b from protruding significantly toward the front side from the motor housing 52b, as illustrated in FIG. 17. As a result, the length of the housing unit 100b in the front-rear direction can be made smaller. In the present example, the other configurations and operations are similar to those illustrated in FIG. 1 to FIG. 10.

### Fourth Example as Yet Another Example of Embodiment

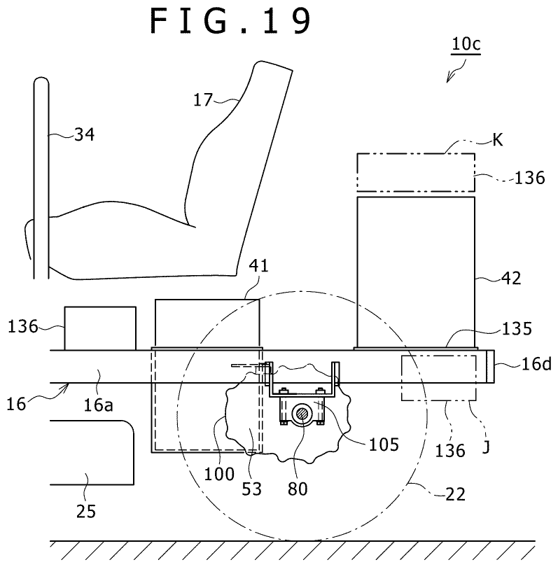

FIG. 19 is a view corresponding to FIG. 3 in yet another example of the embodiment. In a work vehicle 10c of the present example, a plate portion 135 on which the rear batteries 42 are mounted extends between and is fixed to the left and right main frames 16a. The rear batteries 42 are located behind the seat 17. The rear batteries 42 as a whole are arranged above the main frames 16a. The battery 41 on the front side is arranged behind the seat 17, on the front side with respect to the center of the axle 80, and on the rear side with respect to the lawn mowing device 25. In FIG. 19, the cover covering the upper side of the batteries 41 and 42 is not illustrated.

An electrical case 136 may be fixed to the main body frame 16 so that the electrical case 136 is arranged below the seat 17. For example, an electrical case 136 may be fixed to the upper surface of a plate portion (not illustrated) that extends between and is fixed to the two left and right main frames 16a on the front side with respect to the front battery 41. Housed in the electrical case 136 are electrical components such as a controller that transmits control signals to inverter devices for driving the left and right electric motors and inverter devices for driving the electric motors for mower, and contactors connected to the inverter devices.

With the configuration of the present example as well, similar to the configurations of FIGS. 1 to 10, the front battery 41, which is a part of the plurality of batteries 41 and 42, is arranged on the front side with respect to the axle 80, so that it is possible to prevent the weight of the vehicle on the rear side with respect to the axle 80 from being too large. Since the electrical case which contains the controller and various electrical components is arranged below the seat 17, it is easier to place the center of gravity close to the center of the vehicle in the front-rear direction, unlike the case where the controller and various electrical components are exposed to the outside. In the present example, the other configurations and operations are similar to those illustrated in FIG. 1 to FIG. 10.

As illustrated by a two-dot chain line J in FIG. 19, the electrical case 136 which contains the controller and various electrical components may be fixed to the main body frame 16 under the rear batteries 42. Since the electrical case 136 is close to the rear batteries 42, the wiring for connecting the batteries 42 and the electrical case 136 or the components in the electrical case 136 can be shortened.

As illustrated by a two-dot chain line K in FIG. 19, the electrical case 136 which contains the controller and various electrical components may be mounted and fixed above the rear batteries 42. With this configuration as well, since the electrical case 136 is close to the battery 42 on the rear side, the wiring for connecting the battery 42 and the components in the electrical case 136 or the electrical case 136 can be shortened. Since the space above the rear batteries 42 is large, it is easy to install and maintain the electrical case 136.

In the configuration of each example of the above-described embodiment, the inverter devices for driving the left and right electric motors and the inverter devices for driving the electric motors for mower may be housed in two different electrical cases. In that case, the two electrical cases may be in a combination of two positions selected from the position of the electrical case 136 indicated by a solid line in FIG. 19 and the positions of the electrical cases 136 indicated by the two-dot chain lines J and K.

For the configurations of the examples of the above embodiment, various configurations can be adopted as long as the motor shaft 74 of each of the electric motors 70 and 71 is arranged to overlap, along the axle direction, with the corresponding one of the inner portions of circumscribing circles of the maximum outer diameter portions of the axle-integrated rotating members. For example, although the effect of obviating arrangement of the motor housing on the front side far apart from the axles is reduced, the motor shafts of the two left and right motors may be arranged to be different from each other in the front-rear direction. The motor shaft of each motor and the corresponding axle may be arranged so as not to be substantially coaxial with each other.

At least one of the above-described embodiments has the configuration of the work vehicle according to the present disclosure. As a result, the motor housing which houses the left and right electric motors is fixed to the main body frame, and the motor shaft of each of the electric motors rotates the corresponding wheel via the corresponding axle-integrated rotating member, so that it is no longer necessary to provide a dedicated connecting bar for connecting the two axle drive devices to stably maintain the postures of the two wheels. The motor shaft of each of the electric motors is arranged to overlap, along the axle direction, with the corresponding one of the inner portions of circumscribing circles of the maximum outer diameter portions of the axle-integrated rotating members, so that it is possible to obviate arrangement of the motor housing, which houses the electric motors, on the front side far apart from the axles. This makes it easier to arrange a heavy object such as a battery on the lower side of the vehicle and on the front side with respect to the axles. Thus, it becomes easy to optimize the weight balance of the work vehicle.

Therefore, a dedicated connecting bar for connecting the two axle drive devices to stably maintain the posture of the two wheels is not required, and a heavy object is arranged on the lower side of the vehicle to make it easier to optimize the weight balance.

In the work vehicle according to the present disclosure, the motor shafts of the two electric motors may be arranged to overlap with each other along the axial direction. According to the above-described configurations, it is possible to further obviate arrangement of the motor housing which houses the two electric motors on the front side far apart from the axles, so that it becomes easier to optimize the weight balance.

In the work vehicle according to the present disclosure, each of the motor shafts of the two electric motors may be arranged to overlap, along the axle direction, with the inner portion of the circumscribing circle of the maximum outer diameter portion of the corresponding axle. According to the above-described configurations, it is possible to further obviate arrangement of the motor housing which houses the two electric motors on the front side far apart from the axles, so that it becomes easier to optimize the weight balance.

In the work vehicle according to the present disclosure, each of the motor shafts of the two electric motors may be arranged to be coaxial with the corresponding axle. According to the above-described configurations, it is possible to further obviate arrangement of the motor housing which houses the two electric motors on the front side far apart from the axles, so that it becomes easier to optimize the weight balance.

In the work vehicle according to the present disclosure, the two gear housings may be fixed to the main body frame by fastening members inserted in the vertical direction with respect to the main body frame, and the main body frame or the gear housing may be formed with elongated holes which are long in the left-right direction and into which the fastening members are inserted. According to the above-described configuration, unlike the case where the two gear housings are fixed to the main body frame by fastening members inserted in the left-right direction, even if there is an error in the distance between the two gear housings in the left-right direction or the attachment position to the main body frame in the left-right direction, the gear housings can be easily attached to the main body frame without using troublesome means such as adding a spacer or using a low-rigidity material for the main body frame.

What is claimed is:

1. A work vehicle comprising:
a main body frame; and
left and right axle drive devices that drive left and right rear wheels via left and right axles, respectively,
wherein the two axle drive devices include left and right electric motors that are housed and fixed in a motor housing that is fixed to the main body frame, and left and right gear mechanisms that are housed in gear housings that are fixed to left and right ends of the motor housing, and are connected to the respective electric motors to transmit power,
the left and right axles are connected at output sides of the two gear mechanisms, and
each of motor shafts of the two electric motors rotates the corresponding wheel via an axle-integrated rotating member including the axle, the motor shaft being arranged to overlap, along an axle direction, with an inner portion of a circumscribing circle of a maximum outer diameter portion of the axle-integrated rotating member.

2. The work vehicle according to claim 1, wherein
the motor shafts of the two electric motors are arranged to overlap with each other along an axial direction.

3. The work vehicle according to claim 1, wherein
each of the motor shafts of the two electric motors is arranged to overlap, along the axle direction, with the inner portion of the circumscribing circle of the maximum outer diameter portion of the corresponding axle.

4. The work vehicle according to claim 3, wherein
each of the motor shafts of the two electric motors is arranged coaxially with the corresponding axle.

5. The work vehicle according to claim 1, wherein
the two gear housings are fixed to the main body frame by a fastening member inserted vertically with respect to the main body frame, and
the main body frame or the gear housing is formed with an elongated hole which is long in a left-right direction and into which the fastening member is inserted.
